(19) United States
(12) Patent Application Publication
(10) Pub. No.: US 2009/0049409 A1
(43) Pub. Date: Feb. 19, 2009

(54) METHOD FOR GENERATING THUMBNAILS FOR SELECTING VIDEO OBJECTS

(75) Inventors: Xavier LECLERCQ, Creteil (FR); Vladimir PANTELIC, Darmstadt (DE)

Correspondence Address: YOUNG & THOMPSON, 209 Madison Street, Suite 500, ALEXANDRIA, VA, 22314, US

(73) Assignee: ARCHOS SA, Igny (FR)

(21) Appl. No.: 11/839,051

(22) Filed: Aug. 15, 2007

(51) Int. Cl. G06F 3/048

(52) U.S. Cl. 715/838

(57) ABSTRACT

Video thumbnails in portable multimedia players are generated from the normal program content, without the need to resort to stored metadata for the thumbnails. This permits generating thumbnails consistently and accurately for video content from a variety of sources and/or giving a variety of formats.

### BACKGROUND OF THE INVENTION

1. Field of the Invention

The invention pertains to ergonomic and graphical user interfaces. More particularly, the invention provides improved techniques for generating thumbnails that may be used for selecting video objects in portable multimedia players.

2. Description of Related Art

Various publications describe techniques for creating and/or managing thumbnails, including U.S. published patent applications US2006/0210253, US2006/0026524, US2005/0047681, US2004/0095396, US2006/0280449, US2006/0248560, and US2006/0227871, the entirety of which applications is hereby expressly incorporated by reference.

A thumbnail is a convenient and intuitive way to propose a selection of multimedia objects in a graphical user interface. The principle is to present, inside a displayed screen, a plurality of reduced size images that are representative of the corresponding objects that may be selected by a user of the device.

Previously, thumbnails for selecting video objects have been based on specific information, extracted from the real video file (i.e., the video program content) and which was generally stored in a dedicated file. This way of considering the thumbnail as part of the metadata information associated with a video file is carried over from the way that digital music and photos have been managed. Digital music and digital photo standards include metadata having a thumbnail. This metadata is usually provided as additional information inside the multimedia file or it can be provided as a small additional file. This same type of approach has been used for digital video as this more complex domain has been developed after digital photo and music and often by the same actors.

The currently used methods complicate the production of thumbnail information. Dedicated thumbnail information can be provided as metadata delivered with the digital content. In that case, the player needs a dedicated capability to display the thumbnails. However, modern digital video players are potentially capable of handling videos coming from a variety of sources such as video on-demand obtained from Internet, videos extracted from DVD, videos recorded with external peripheral devices like digital video cameras or internally in the case of digital video recorders.

This variety of video sources and standards may pose difficulties for the thumbnail techniques conventionally used.

### SUMMARY OF THE INVENTION

The invention aims to solve or alleviate one or more of the problems associated with the prior art solutions. Preferred embodiments of the invention provide to users of portable electronic multimedia players a convenient, effortless and universal way to see and select the digital videos which they have stored in their device. They also provide to manufacturers of such products, a smart solution which can be entirely based on software, and is easy to develop and to implement

According to preferred embodiments of the invention, thumbnails are not considered as metadata associated with a digital video object but only as part of the graphic user interface. That is, these embodiments do not use specific information to display thumbnails as in prior methods, but instead use only the normal video data (program content) which is received and/or stored for use to be normally displayed.

This permits addressing effectively the problem of consistency among the potentially multiple digital video sources and formats. Due to the fact that the embedded decoding infrastructure for normal videos may also be used to produce the thumbnails displayed in the graphic user interface, all the videos that can be played in an apparatus according to the preferred embodiments of the invention, can be used to produce a corresponding thumbnail with no special effort.

### BRIEF DESCRIPTION OF THE DRAWINGS

FIG. 1 shows the architecture of a typical implementation of the invention.

FIG. 2 is an illustration of different ways of presenting the thumbnails within the screen.

FIG. 3 illustrates the use of an embodiment of the invention for navigating in tree structures.

### DETAILED DESCRIPTION OF PREFERRED EMBODIMENTS

In the following description, the term “thumbnail” means a small surface homothetic reduction of a still or moving picture extracted from a digital video object. “Standard” refers to decoding and storage that is not specific to thumbnail generation. “Decoding” means transforming digital information associated with a video object into a video image. “Freezing video” means stopping the moving of the images in a video flow. “Freeze” and “play” refer to control of the way a video is seen by the user inside a thumbnail, as either a static image captured from the video flow or a moving video inside the thumbnail box. This control can be done directly by controlling the pause/play command of a standard digital video decoder. It can also be done through sampling/mapping of decoded output at a display screen building level.

The selection of digital videos according to the invention is based on the building of at least one displayed page that contains at least one thumbnail wherein the pixels displayed in the surface of the thumbnail come from the normal video player applied to the corresponding real video file. Depending on the capability for the normal decoder/playback facility to accept different working parameters on the fly from the calling application to adapt the decoded image size and resolution, an additional resizing step may be needed to fulfil the thumbnail resizing requirements. Another advantage of the invention is the capability to use the standard freeze/play video command of the video player. It is then possible to use the ability to show a moving video or a still picture corresponding to the last image displayed before the pause command. In another embodiment, the application in charge of the selection image building maps the output of the video decoder to the corresponding area of the screen that corresponds to the thumbnail to be displayed. In order to build the selection screen including at least one thumbnail, this application scans all the video files to be proposed and plays them in the corresponding thumbnails. Depending on the available processing power, all the thumbnails can show a moving picture, or none, or some with motion and some without. A good compromise, specifically in the case of portable multimedia players in which the processing power is limited, is to display moving pictures in only one thumbnail among a given group.

Many improvements are possible within the scope of the invention. For example, in products that do not embed a touch screen or any other pointing device, the selection of an object is generally based on a sequential process in which the user explores the possible choices on an item by item basis. The invention can help for a better ergonomics in the selection process while displaying moving video only in one thumbnail among the selected group. In a sequential selection process, the thumbnail that shows a moving video is the one that will be selected in case of validation by the user. Navigation tools allow the user to explore all the possible choices indicating the potentially selectable object in making its thumbnail display a moving video while objects not currently selectable objects display a frozen picture in their corresponding thumbnails.

The thumbnail loading sub stage which is included in the screen building stage of this method, is based on the sampling and/or the playing of the corresponding video files to be played.

The invention provides a second level management capability within the selection process when the thumbnails are introduced in order to propose to users the selection of video that represents a bundle of episodes of the same series. This is particularly advantageous in the case of TV shows or series that are often delivered by bundle of some episodes within a “season” (when they were initially broadcast) or are packaged as a whole season of episodes. It is more convenient for users to propose in the same selection screen, the short format videos as aggregated bundles under the same thumbnails among those that are associated with long format videos. As this “aggregated content” does not exist as such, the header displayed in a thumbnail which is associated with a bundle of some episodes can be obtained by the sampling of only one of the said episodes involved in this aggregation. The content displayed in a thumbnail which is associated with a bundle can also be produced by sampling the content of more than one of the concerned episodes. The representative header to be displayed can also be moving or static graphical and/or textual information associated with the bundle of episodes. For example the title of the series displayed as an endless rolling string of characters inside the thumbnail to be equivalent to a moving video in the selection process. The rolling of the character string stops when it has to correspond to a frozen video in the selection process.

An efficient management of short format videos is interesting in the case of portable multimedia players as it corresponds to a category of videos that is well-suited to viewing on the go.

The ability to point to a specific episode, among several, contained in the same file supposes a prior indexation and/or the presence of tags as metadata in the file.

The reference to a “video object” instead of a “video file” is due in part to the fact that the video can be stored locally, stored in a remote connected device like a PC and any equivalent services based on streaming or video broadcasting. In this variant the streaming server first sends some small clips which are stored in the PMP and which correspond to the videos proposed to the user. These clips are the “video objects” which are played and displayed in the thumbnails. The selected thumbnail launches the corresponding video viewing, in streaming, but it makes no difference relative to the variant based on local storage of the video files.

For each thumbnail image production, the video decoder applied to the standard video content skips a constant or random playing duration at the beginning of the video object.

During the navigation by the user through the list of items, a same thumbnail can several times be proposed. The corresponding video can also resume playing where it was previously stopped at each new sampling of said video. A constant or random playing duration between each new sampling of said video object can also be skipped.

While being selected, a thumbnail can also display an endless sampling of corresponding video, at a normal speed as well as at accelerated speed, or a sequence that alternates normal and accelerated speed.

Referring now to FIG. 1, video files are stored in a mass storage memory (8). These files are decoded using a normal decoder (6) that normally plays the video in the apparatus. This normal decoder is that normally used in the device to decode video for a full screen display. Once decoded, the video is brought to a selector (5) which switches the video steam towards a full screen display (11) or towards a display of the video inside a thumbnail (1). The selector (5) is driven under control of the selection process (9). Depending on implementation, some video decoders can be adapted on the fly in order to produce an output already sized for a given final image size and resolution set by the calling application. In some other types of implementation, the output characteristics of the video decoder are dedicated to one final size and resolution. In this case, an adaptation module (4) is needed to adapt the incoming video stream for a display inside a thumbnail. The selectors (3) and (7) are driven together under control of the selection process (9) in order to associate always the same video object to the same thumbnail. The selection process (9) also monitors the user interface (10) in order to let him choose a video object. This user interface (10) can be of any type, for example a keyboard, a touch screen, a touch pad, a joystick, a trackball, speech recognition or the like.

The selection process can be done inside a continuous list of thumbnails which exceeds the displaying capability of one screen. This list can be explored in scrolling mode by any usual way like navigation keys, sliders or the like.

The exploration of the thumbnails can also be done in a page by page mode without being out of the scope of the invention. It can be done for example through the addition of specific thumbnails dedicated to the navigation within the displayed pages or by dedicated keys, icons in combination with a touch screen, a touch pad or any other pointing device.

The method for a video selection according to this embodiment of the invention comprises the following stages:
Explicit or implicit call of the selection menu (16)
Choice in the selection menu of one video object or one video category among a plurality of video objects and/or categories,
Explicit or implicit choice validation,
Play the selected video full screen or call of another menu in a multilevel tree structure.

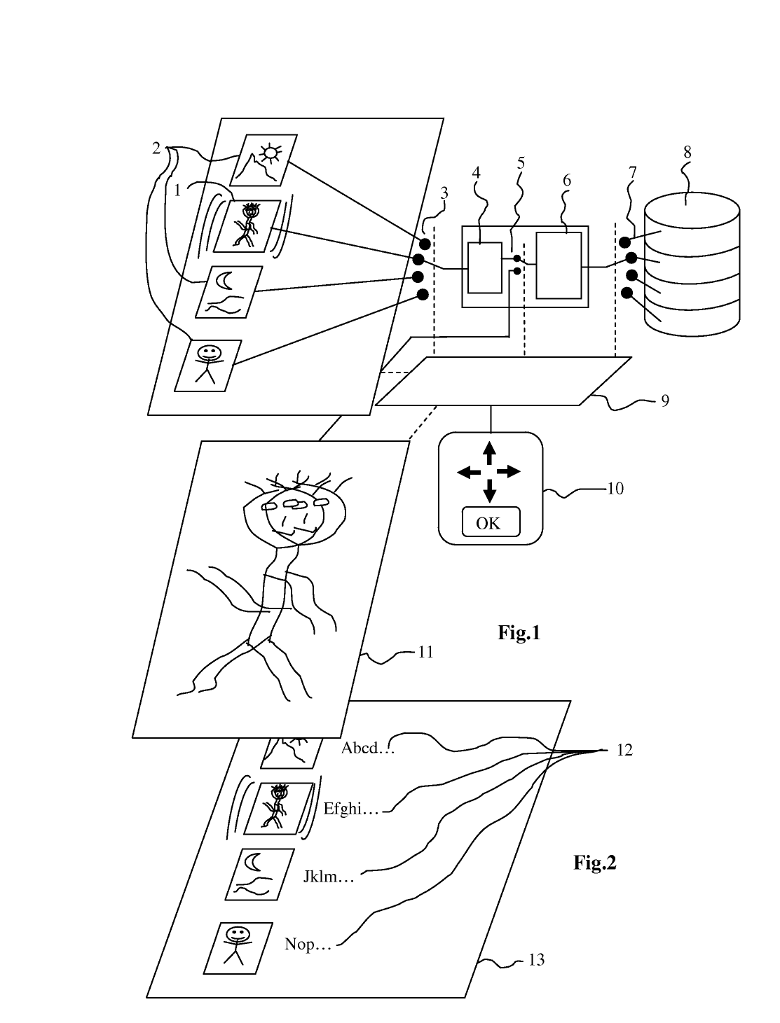

FIG. 2 illustrates that each thumbnail can be presented in a screen in a variety of formats, e.g., enriched by complementary information like title, genre, and name of actors.

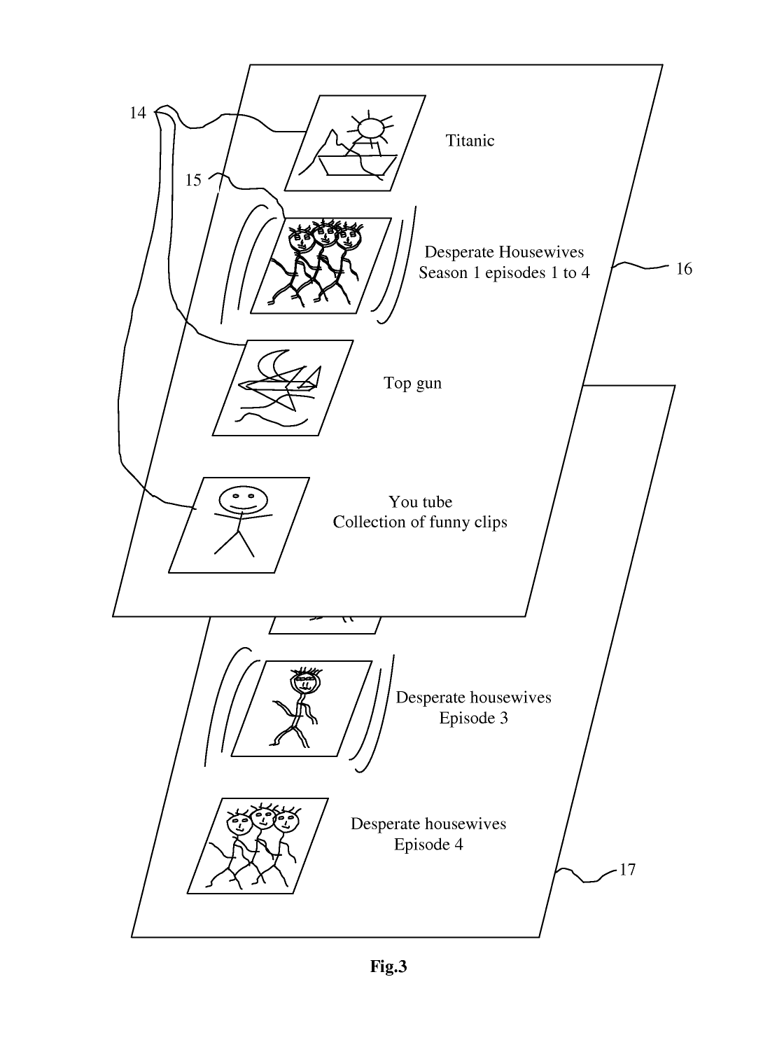

FIG. 3 shows how the selection method according to the invention can manage a tree structure. On a first screen (16), for example, a bundle of episodes of the series “Desperate housewives” (15) has been selected. The screen (17) is then displayed showing the episodes which can be selected to be played. The selection method within the said second display is the same as within the said first display.

Advantageously, specific thumbnails dedicated to the navigation can be added within the screens in order to give at least a way to go back to the previous screen. These additional thumbnails can display a still picture or a moving picture according to the selection process of the invention. Concerning these specific thumbnails, which are not associated with a video object but which may be added within the selection process according to the invention, they may use a different method and/or means than those implemented for video.

Although the invention has been described above in connection with various preferred embodiments thereof, it will be appreciated by those skilled in the art that these embodiments are provided solely to illustrate the invention, and should not be used as a pretext for construing the invention in a limiting way. To the contrary, various modifications, improvements and substitution of equivalent techniques will be apparent to those skilled in the art upon reading this specification, and all such modifications, improvements, substitutions and equivalents are considered to be embraced by the true scope and spirit of the appended claims.

What is claimed is:

1. A method for generating at least one thumbnail for selecting a video object from a plurality of video objects stored in a portable multimedia player, comprising:
identifying video objects that can be accessed if selected; and
generating at least one screen for selection that includes at least one thumbnail, each said thumbnail being associated with at least one stored video object proposed for selection and being generated by standard embedded video decoding applied to corresponding standard video content.

2. The method according to claim 1, further comprising:
resizing a video image to fit in a thumbnail surface.

3. The method according to claim 1, further comprising:
adapting a resolution of said standard embedded video decoding to be compatible with a thumbnail display.

4. The method according to claim 1, wherein said generating at least one screen for selection that includes at least one thumbnail comprises:
sampling stored video objects; and
redirecting adapted video images from an output of said standard embedded video decoding toward thumbnails corresponding to said stored video objects.

5. The method according to claim 4, further comprising selecting a thumbnail among a plurality of thumbnails using a freeze and play control for video displayed inside each thumbnail surface.

6. The method according to claim 5, wherein each of said plurality of thumbnails shows a frozen image except one which plays moving pictures.

7. The method according to claim 5, wherein each of said plurality of thumbnails shows moving pictures except one which shows a frozen image.

8. The method according to claim 6, wherein said one thumbnail corresponds to a video object that will be played at full screen size and full resolution if selected by a user.

9. The method according to claim 1, further comprising:
performing a second level management within a selection process based on said plurality of thumbnails.

10. The method according to claim 9, wherein each thumbnail dedicated to said selection process displays in an endless loop a header that is representative of a corresponding bundle of video episodes.

11. The method according to claim 9, wherein each thumbnail dedicated to said second level management displays in an endless loop, a corresponding video episode.

12. The method according to claim 1, wherein said standard embedded video decoding comprises decoding of a video object for each thumbnail image production that skips a constant playing duration at the beginning of each said video object.

13. The method according to claim 1, wherein said standard embedded video decoding comprises decoding of a video object for each thumbnail image production that skips a random playing duration at the beginning of each said video object.

14. The method according to claim 1, wherein said standard embedded video decoding comprises decoding of a video object for each thumbnail image production that resumes playing where it was previously stopped at each new sampling of said video object.

15. The method according to claim 1, wherein said standard embedded video decoding comprises decoding of a video object for each thumbnail image production that skips a constant playing duration between each new sampling of said video object.

16. The method according to claim 1, wherein said standard embedded video decoding comprises decoding of a video object for each thumbnail image that skips a random playing duration between each new sampling of said video object.

17. The method according to claim 1, wherein said standard embedded video decoding comprises decoding of a video object for each thumbnail image production that shows an endless sampling of said video object in at least one thumbnail.

18. The method according to claim 1, wherein said standard embedded video decoding comprises decoding of a video object for each thumbnail image production that shows an endless playing of said video object at normal speed in at least one thumbnail.

19. The method according to claim 1, wherein said standard embedded video decoding comprises decoding of a video object for each thumbnail image production that shows an endless playing of said video object at accelerated speed in at least one thumbnail.

20. The method according to claim 1, wherein said standard embedded video decoding comprises decoding of a video object for each thumbnail image production that shows an endless playing of said video object in sequences that alternates normal and accelerated speed in at least one thumbnail.
